(19) United States
(12) Patent Application Publication
(10) Pub. No.: US 2015/0103532 A1
(43) Pub. Date: Apr. 16, 2015

(54) Light Fixture with Retractable Blocking Device for an Expanding Lens

(71) Applicant: Focal Point LLC, Chicago, IL (US)

(72) Inventors: Stephen Krotseng, Chicago, IL (US); Jeremy Taylor, Chicago, IL (US); Michael SanFacon, Chicago, IL (US)

(73) Assignee: Focal Point LLC, Chicago, IL (US)

(21) Appl. No.: 14/052,175

(22) Filed: Oct. 11, 2013

(51) Int. Cl. F21V 5/04

(52) U.S. Cl. CPC F21V 5/04
USPC 362/311.02; 362/311.01; 362/311.04

(57) ABSTRACT

In an embodiment, a light fixture is provided that includes a housing, a lens configured to mount to the housing, a plate, and a light source located inside the housing. The housing may include a top panel, a pair of side panels, and a pair of end panels. The lens may have a length shorter than a longitudinal length of the housing, thereby creating a gap between the lens and at least one end panel of the housing. The plate may be attached to one of the pair of end panels. The plate may include a flat portion that attaches to the end panel and an angled portion that is angled away from the end panel. The angled portion may cover the gap between the lens and the housing.

### FIELD OF THE INVENTION

The present invention relates to housing and lenses used for light fixtures, more specifically a retractable blocking device for an expanding lens and housing used for LED recessed light fixtures.

### BACKGROUND

Light fixtures and recessed light fixtures are known, and are typically used when it is desirable to minimize the projection of the light fixture below the ceiling surface. Recessed light fixtures tend to be more aesthetically appealing and provide a cleaner look when installed. Light fixtures that substantially extend below the ceiling surface may also be utilized. Recessed light fixtures tend to be used in commercial settings such as offices and the like.

Generally, light fixtures such as these may include a plastic lens attached to the housing.

As the plastic lens is heated up by a light source, such as LEDs, the plastic lens expands when it is heated. To offset and accommodate this heated expansion, the plastic lens is generally made shorter in length than the longitudinal length of the light fixture housing. With the plastic lens shorter in length, a small gap at one or both ends of the fixture is created, which allows someone under the light fixture to see into the internal housing of the light fixture. This can be a problem with LEDs and other light sources and light fixtures of the like. What is needed is a lens and light fixture that can block the unsightly gaps that are created with a plastic lens and an LED light source for a light fixture.

### BRIEF SUMMARY OF THE INVENTION

In an embodiment, a light fixture is provided that includes a housing, a lens configured to mount to the housing, a plate, and a light source located inside the housing. The housing may include a top panel, a pair of side panels, and a pair of end panels. The top panel may be attached to a top of each of the side panels and each of the two end panels to form the housing. The lens may have a length shorter than a longitudinal length of the housing, thereby creating a gap between the lens and at least one end panel of the housing. The plate may be attached to one of the pair of end panels. The plate may include a flat portion that attaches to the end panel and an angled portion that is angled away from the end panel. The angled portion may cover the gap between the lens and the housing.

In another embodiment, a light fixture is provided that includes a housing, an LED-based light source located inside the housing, a lens configured to mount to the housing, and a first plate attached to a first end panel of the housing. The housing may include a top panel, a pair of side panels, and a pair of end panels, wherein the top panel may be attached to a top of each of the side panels and each of the two end panels to form the housing. The lens may have a length shorter than a longitudinal length of the housing, thereby creating a gap between the lens and at least one end panel of the housing. The first plate may include a flat portion that attaches to the first end panel and an angled portion that extends from the flat portion of the first plate at an angle defined as between approximately 10 degrees and approximately 60 degrees. The angled portion of the first plate may cover the gap between the lens and the housing, wherein the angled portion of the first plate retracts against the lens as the lens expands due to heat from the light source.

Additionally, another embodiment may further include a second plate attached to a second end panel. The second plate may include a flat portion that attaches to the second end panel and an angled portion that extends from the flat portion of the second plate at an angle defined as between approximately 10 degrees and approximately 60 degrees. The angled portion of the second plate covers the gap between the lens and the housing, wherein the angled portion of the second plate retracts against the lens as the lens expands due to heat from the light source.

### BRIEF DESCRIPTION OF THE DRAWINGS

The present invention is illustrated by way of example and not limited in the accompanying figures in which like reference numerals indicate similar elements and in which:

FIG. 1 is an illustration of a bottom-angled perspective view of an embodiment of a housing and lens of a light fixture in accordance with aspects of this invention.

FIG. 2 is an illustration of a bottom perspective view of the housing and lens of the light fixture of FIG. 1 in accordance with aspects of this invention.

FIG. 3A is an illustration of a side perspective view of a plate used with the housing in accordance with aspects of this invention.

FIG. 3B is an illustration of another side perspective view of the plate shown in FIG. 3A in accordance with aspects of this invention.

FIG. 3C is an illustration of a side view of the plate shown in FIG. 3A in accordance with aspects of this invention.

FIG. 4 is an illustration of a bottom side-angled perspective view of a portion of a light fixture with a plate installed in accordance with aspects of this invention.

FIG. 5 is an illustration of a bottom angled perspective view of the portion of the light fixture and plate illustrated in FIG. 4 in accordance with aspects of this invention.

FIG. 6A is an illustration of a side perspective view of a portion of a light fixture and a plate with the lens not expanded against the plate in accordance with aspects of this invention.

FIG. 6B is an illustration of a side perspective view of the portion of light fixture and the plate illustrated in FIG. 6A, with the lens expanded fully against the plate and the end of the housing in accordance with aspects of this invention.

The reader is advised that the attached drawings are not necessarily drawn to scale.

### DETAILED DESCRIPTION OF THE INVENTION

In the following description of various example embodiments of the invention, reference is made to the accompanying drawings, which form a part hereof, and in which are shown by way of illustration various example structures, devices, systems, and environments in which aspects of the invention may be practiced. It is to be understood that other specific arrangements of parts, structures, example devices, systems, and environments may be utilized and structural and functional modifications may be made without departing from the scope of the present invention. Also, while the terms “top,” “bottom,” “front,” “back,” “side,” and the like may be used in this specification to describe various example features and elements of the invention, these terms are used herein as a matter of convenience, e.g., based on the example orientations shown in the figures. Nothing in this specification should be construed as requiring a specific three dimensional orientation of structures in order to fall within the scope of this invention.

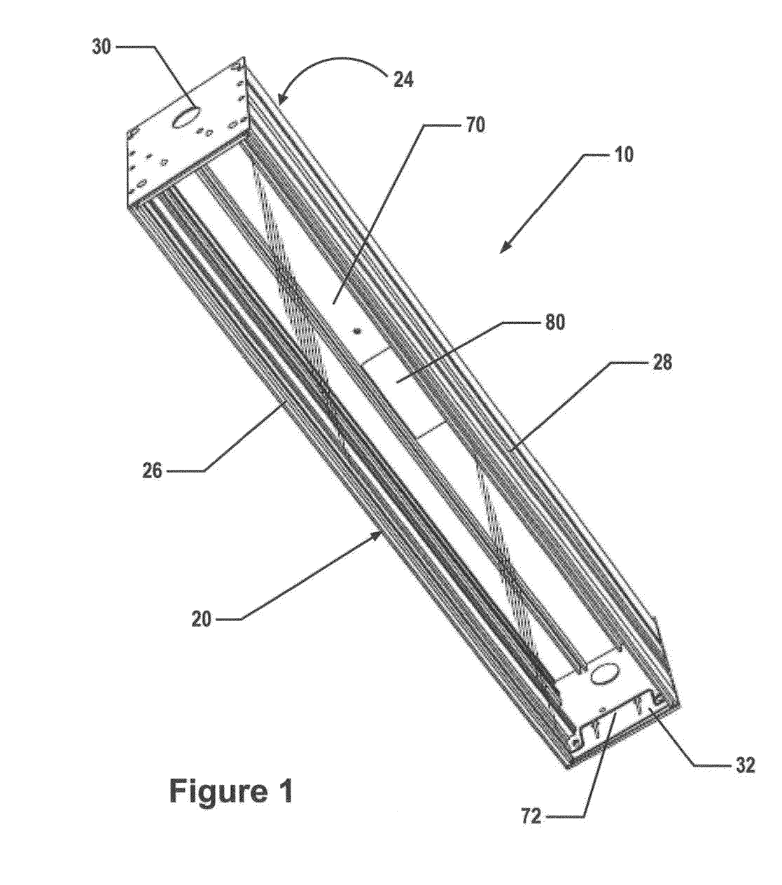

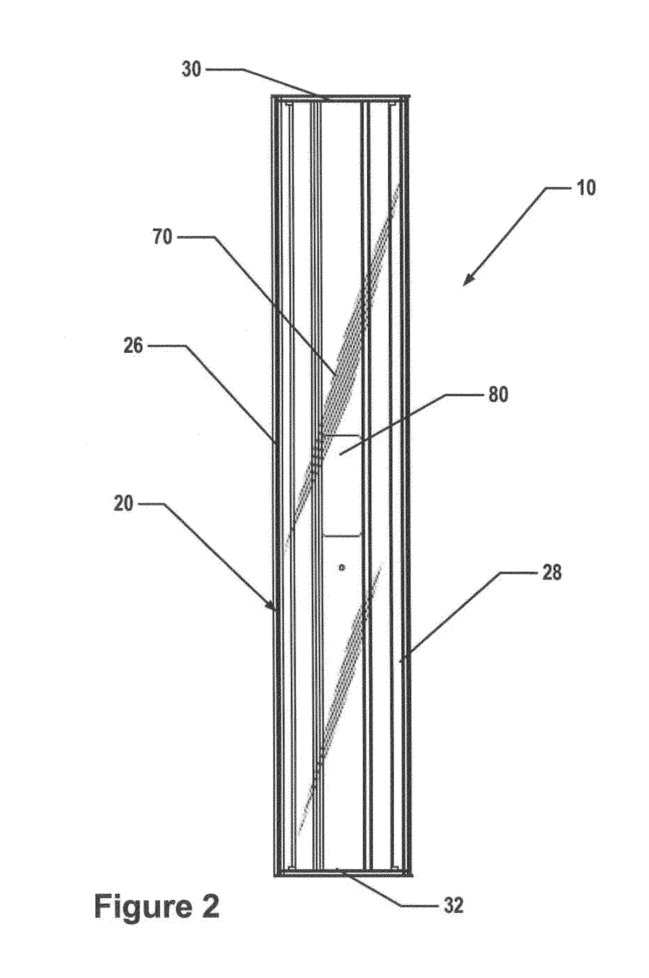

Referring to FIGS. 1 and 2, a light fixture 10 includes a housing 20, a lens 70, a light source 80, and a plate 100 attached to the housing. The plate 100 may be attached to the housing 20 to block a gap 72 between the lens 70 and the housing 20. The gap 72 may be created by a shortened lens 70 as compared to the longitudinal length of the housing to accommodate the plastic that expands when the lens 70 is heated. The plate 100 may be attached to the fixture housing 20 such that the plate 100 moves or retracts with the expanding lens 70 as the fixture 10 and light source 80 heats up the lens 70.

As illustrated in FIGS. 1 and 2, the housing 20 includes a top panel 24, a pair of opposing side panels, 26, 28, and a pair of opposing end panels 30, 32. FIG. 1 is an illustration of a bottom-angled perspective view of the housing and the lens of the light fixture. FIG. 2 is an illustration of a bottom perspective view of the housing and the lens of the light fixture. The housing 20 may be rectangular in shape. In other embodiments without departing from the invention, the housing 20 may be square or other shapes. The housing 20, which may be made of any desirable material, such as but not limited to aluminum or steel, provides a certain level of protection for the light fixture 10 and the light source 80 and also can protect the surrounding area from heat produced by the light fixture 10. The top panel 24, side panels 26, 28, and the end panels 30, 32 create a rectangular-shaped housing. Additionally, the top panel 24 is attached to the top of each of the side panels 26, 28 and the two end panels 30, 32 to complete the structure of the housing 20. The housing 20, which may be made of any desirable material, such as but not limited to aluminum or steel, provides a certain level of protection for the light source and also can protect the surrounding area from heat produced by the light source 80.

Referring again to FIG. 1, the invention includes a lens or diffuser 70. The lens 70 may be preferably made of a DR high impact frosted acrylic material. The lens 70 may also use added color for an opaque appearance. Preferably the lens 70 may be integrally formed as a single, solid but flexible piece of extruded acrylic.

As shown in FIGS. 1 and 2, a lens 70 may be rectangular and fit over the housing 20.

Other shapes and sizes may be utilized for the lens 70 without departing from the invention. For example, the lens 70 may include curved surfaces fitting over the housing 20. The lens 70 may include multiple linear prisms that extend the full longitudinal direction of the lens 70. The linear prisms may diffuse and distribute light from the light source 80 more evenly and thus avoid the appearance of “hot spots,” or focused light, emanating from the fixture.

The lens 70 is preferably constructed of a flexible material so that it can be flexed and bent to engage the light fixture 10 as described above without cracking As was discussed above, when the light source 80 is powered on for an extended period of time, the lens 70 may expand due to thermal expansion. Therefore, to offset this thermal expansion, the lens 70 may be shorter in length than the longitudinal length of the housing 20. The lens 70 may not extend completely to the housing 20 and the end panel 30, 32. The lens 70 may be shorter than the housing 70 to allow for and offset the thermal expansion when the light source 80 is powered on for an extended period of time. Because the lens 70 is shorter than the housing 20, there may be a gap 72 formed between the lens 70 and the housing 20. The gap 72 may provide a visual opening to the housing 20 and allow a person looking at the light fixture 10 to see into the internal structure of the housing 20. Seeing the internal structures of the housing 20 may be un-aesthetically pleasing to a user or person looking at the light fixture 10.

As shown in FIGS. 1 and 2, the lens 70 may be positioned over the open portion of the housing 20. The lens 70 is provided to cover the light source 80. The lens 70 may be utilized for a number of different purposes. First, the lens 70 may be utilized to provide thermal isolation from the light source 80 and the external surroundings to the light fixture 10. The lens 70 may also be utilized to meet safety requirements to protect a user from touching or contacting the light source 80. Third, the lens 70 provides protection to the light source 80 from debris, or dust that could possibly damage the light source 80.

Additionally, the lens 70 may include optical lens properties. The lens 70 may be a plastic lens. The lens 70 may be frosted, clear, prism, or other characteristics depending on the requirements of the light source 80. Additionally, the lens 70 may include reflective properties. The lens 70 may help focus and direct light from the light source. In an embodiment, the lens 70 may collect the light beams, including side light and stray light from the light source 80. Additionally, the lens 70 may be provided to help focus the beam of light through the housing to reduce the light bouncing on the inside of the housing surface.

As can be appreciated, various known electrical components typically used in a light source fixture are required. These components are known in the art and, therefore, further discussion regarding the various electrical components is not required. The housing 20 may additionally include one or more holes suitable for the purpose of either accepting wires and/or for allowing various electrical components to be installed within or connected (either directly or indirectly) to the housing in a known manner. For example, the light source 80 may include LED lights in any configuration as known and used in the art. Additionally, the light source 80 may include T5 high output bulbs configured to provide reflectivity for the high output linear light sources. Additionally, the light source 80 may include T8 bulbs configured to provide reflectivity for the high output linear light sources.

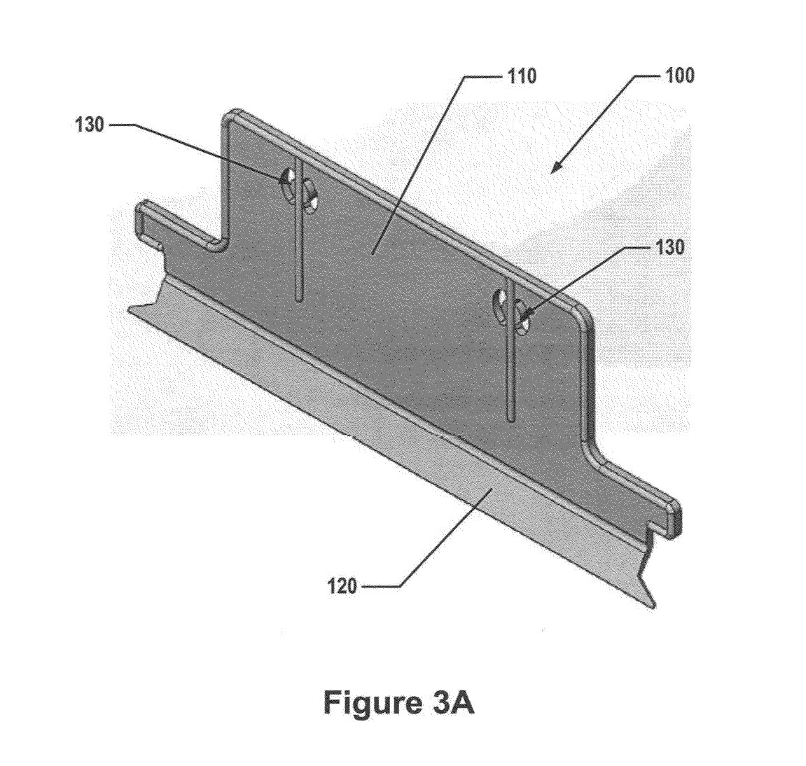

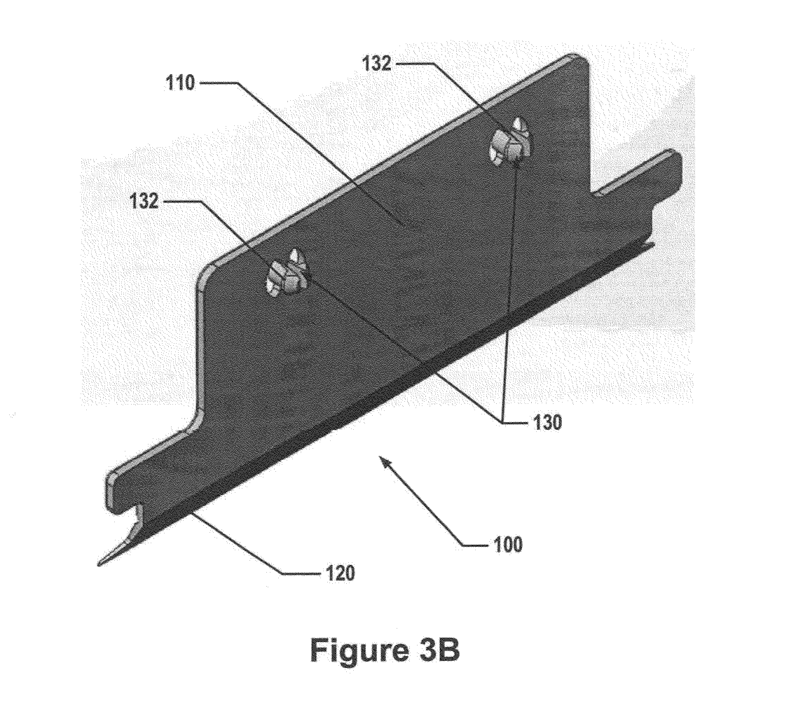

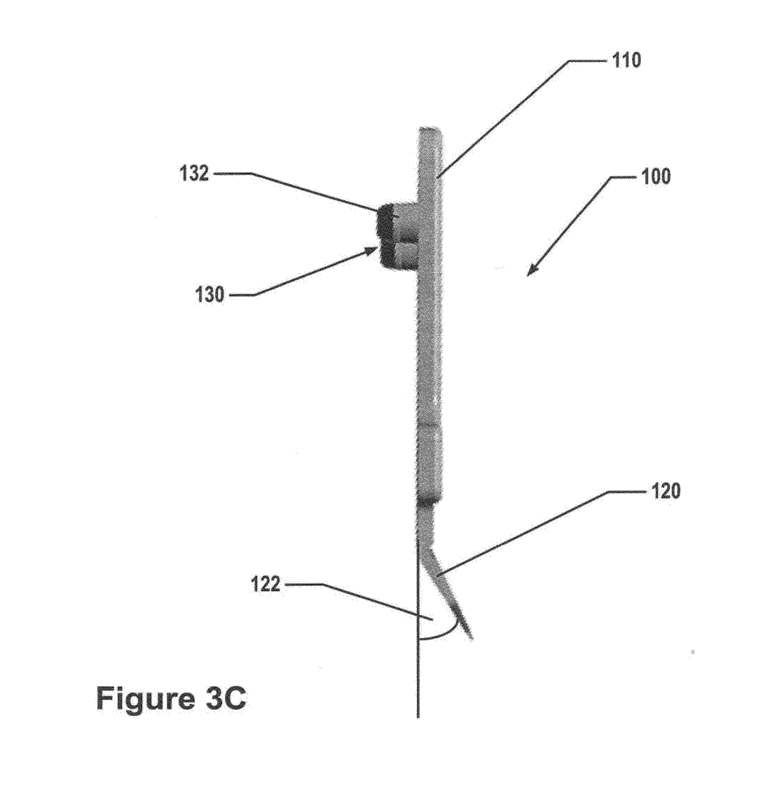

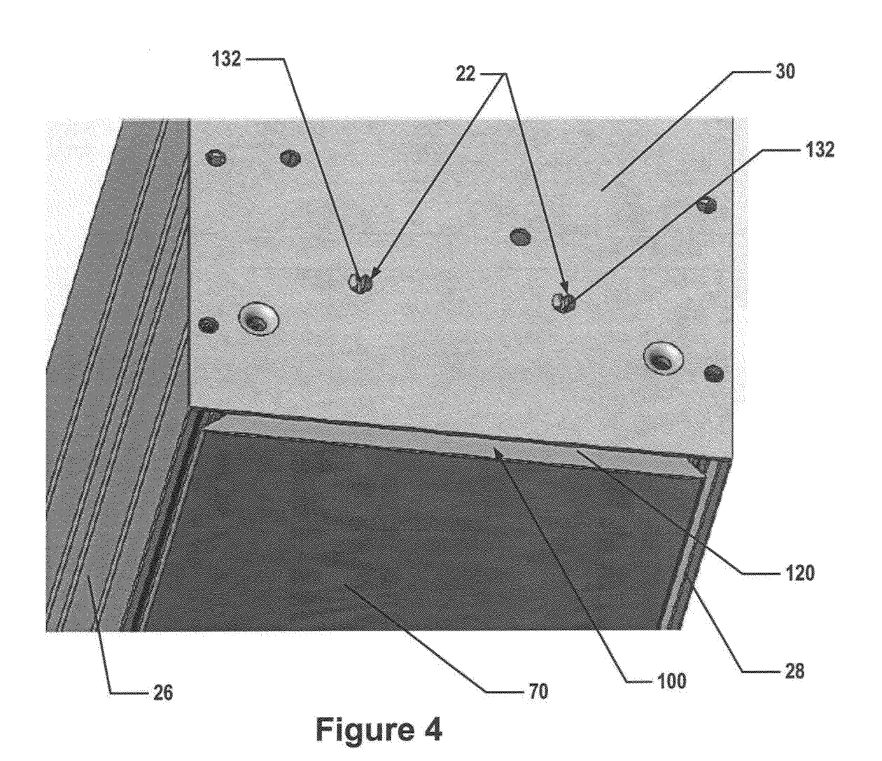

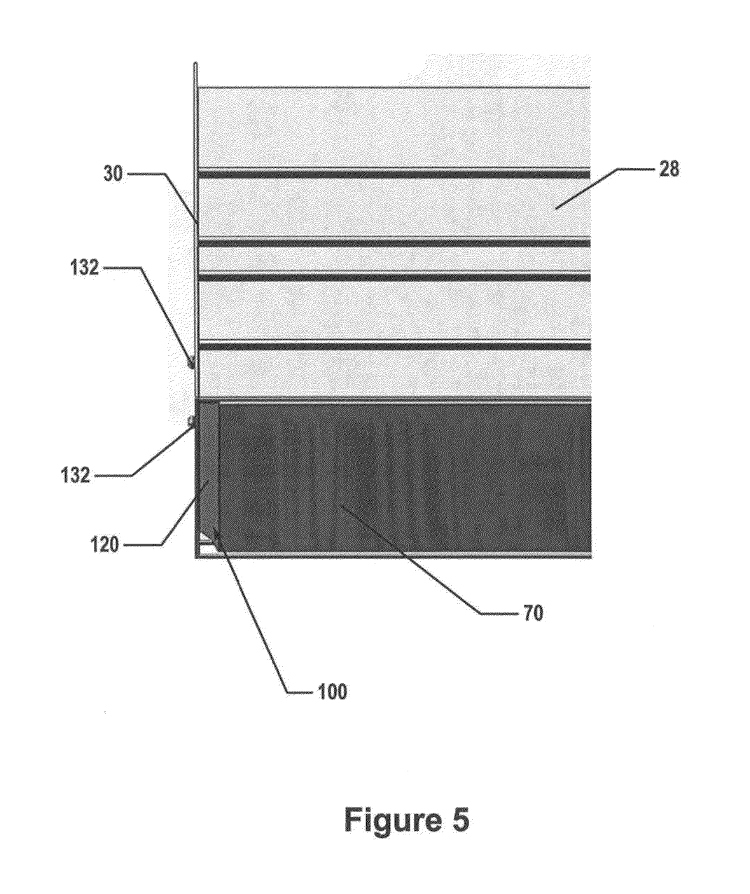

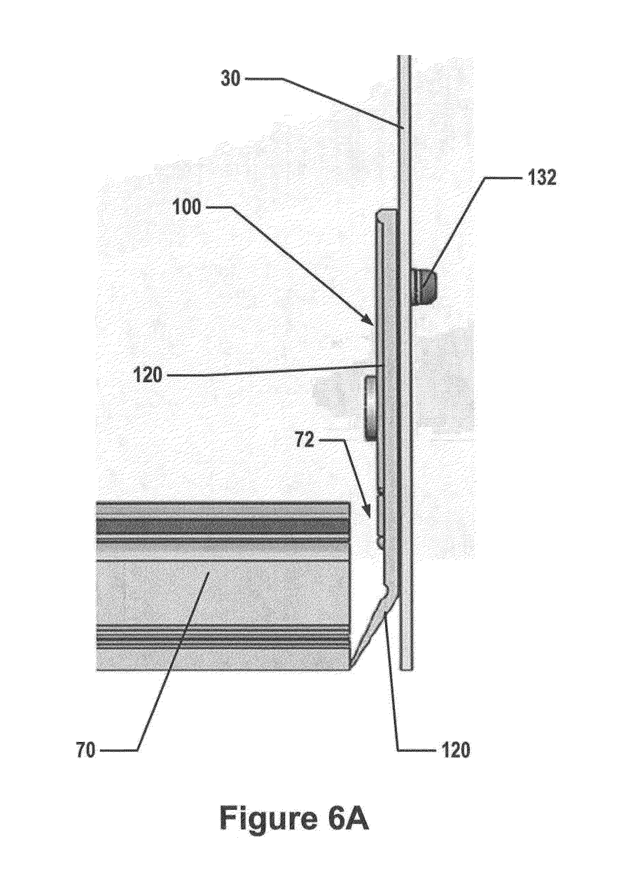

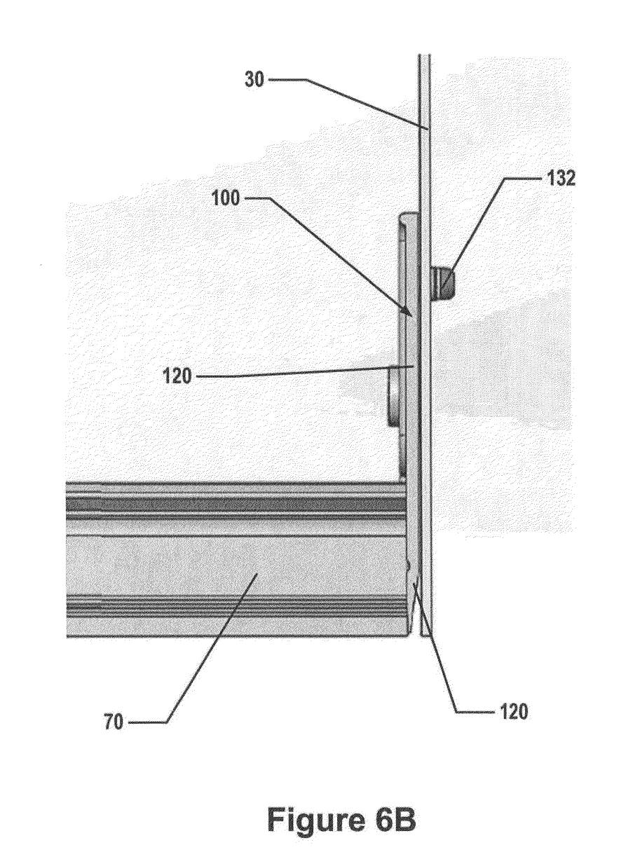

FIGS. 3A through 6B illustrate the plate 100 and the plate 100 attached to the housing 20. Generally, the plate 100 may be configured to be engaged with or attached to the housing 20. Specifically, FIGS. 3A through 3C illustrate various views of the plate 100. FIGS. 4 and 5 illustrate portions of the light fixture 10, housing 20, and plate 100. FIGS. 6A and 6B illustrate side perspective views of the portion of light fixture 10 and the plate 100, with the lens 70 not expanded (FIG. 6A) and expanded fully (FIG. 6B) against the plate 100 and the end of the housing 20.

The plate 100 may be made of any desirable material, such as but not limited to plastic or thermoplastic materials. The desirable material for the plate 100 may allow the plate 100 to bend and be flexible. The plate 100 may be formed using an injection molding process. Aluminum or steel may also be utilized for the plate without departing from this invention as long as the can bend and be flexible. The plate 100 may have a flat portion 110 and an angled portion 120. The angled portion 120 may extend from the flat portion 110 at an angle 122. The angle 122 may be defined as between 5 and 80 degrees in one embodiment. In other embodiments, the angle 122 may be defined as between 10 and 60 degrees, or 10 and 30 degrees.

The plate 100 may include an attaching portion 130 that attaches to and/or engages one of the end panels 30, 32 of the housing 20. The attaching portion 130 or attaching mechanism may preferably be located on the flat plate portion 110. FIGS. 3B and 3C illustrate an exemplary attaching portion 130 for the plate 100. As illustrated in FIGS. 3B and 3C, the attaching portion 130 may include a snap-fit protrusion 132 that snaps into a hole 22 that is located on end panel 30, 32 of the housing 20. The attaching portion 130 may include one snap-fit protrusion 132 or more than one snap-fit protrusion 132 without departing from this invention. Other attaching mechanisms may be utilized without departing from this invention. For example, the attaching portion 130 may include a screw that attaches to a mechanical fastener on the end panel 30, 32 of the housing 20. Additionally, the end panel 30, 32 of the housing 20 may include a screw that attaches to a mechanical fastener on the plate 100. In another example without departing from the invention, the end panel 30, 32 of the housing 20 may include a protrusion that snap-fits into a hole located on the plate 100. Various other attaching mechanisms known and used in the art may be utilized without departing from this invention.

In another embodiment, the plate 100 may be integrally formed as part of the end panel 30, 32 of the housing 20. When the plate 100 is integrally formed as part of the end panel 30, 32 of the housing 20, the angled portion 120 may extend from the end panel 30, 32.

Additionally, the plate 100 and the attaching portion 130 may include an adjustment portion that allows the plate 100 to be adjusted along the end panel 30, 32 of the housing 20. The plate 100 may be adjusted either up and down or side to side longitudinally along the end panel 30, 32 of the housing 20. This adjustment may be utilized in order to accommodate various lens 70 configurations and housing 20 configurations. The adjustment portion may be a slide fastener with a slot that allows the plate 100 to slide up and down or side to side as known and used in the art. Other adjustment mechanisms known and used in the art may be utilized without departing from this invention.

FIGS. 6A and 6B illustrate the plate 100 installed on the end panel 30 of the housing 20. In FIG. 6A, the lens 70 is not thermally expanded, such as when the light source 80 is not powered on. As is illustrated in FIG. 6A, the plate 100 covers the gap 72 between the lens 70 and the housing 20. Specifically, the angled portion 120 of the plate 100 covers the gap 72 between the lens 70 and the housing 20. FIG. 6B illustrates the lens 70 after the lens 70 has thermally expanded against the housing, such as when the light source 80 has been powered on for a period of time. As is illustrated in FIG. 6B, the angled portion 120 provides a biasing action against the expanding lens 70 and allows the lens 70 to thermally expand and longitudinally towards the end panel 30, 32 of the housing 20. The biasing of the angled portion 120 of the plate 100 keeps the engagement between the lens 70, the plate 100, and the end panel 30, 32 of the housing 20. As the lens 70 thermally expands, the lens 70 expands against the angled portion 120 of the plate 100. Because of the flexibility of the materials of the plate 100 and the angled portion 120 of the plate, as the lens 70 thermally expands, the angled portion 120 of the plate 100 bends closer to the end panel 30, 32 of the housing 20.

In one embodiment without departing from the invention, one plate 100 may be engaged to one end panel 30. In another embodiment, a first plate 100 may be engaged to a first end panel 30 and a second plate 100 may be engaged to a second end panel 32, with both plates 100 being used to cover a gap 72 on each side of the lens 70.

In another embodiment, the plate 100 may be engaged to other portions of the housing, such as being engaged with or attached to the side panels 26, 28 of the housing 20.

The present invention has been described in terms of preferred and exemplary embodiments thereof. Numerous other embodiments, modifications and variations within the scope and spirit of the appended claims will occur to persons of ordinary skill in the art from a review of this disclosure.

We claim:

1. A light fixture, comprising:
a housing, the housing comprising a top panel, a pair of side panels, and a pair of end panels, wherein the top panel is attached to a top of each of the side panels and each of the two end panels to form the housing;
a lens configured to mount to the housing, the lens having a length shorter than a longitudinal length of the housing, thereby creating a gap between the lens and at least one end panel of the housing;
a plate attached to one of the pair of end panels, wherein the plate includes a flat portion that attaches to the end panel and an angled portion that is angled away from the end panel, wherein the angled portion covers the gap between the lens and the housing; and
a light source located inside the housing.

2. The light fixture of claim 1, wherein the angled portion retracts against the lens as the lens expands due to heat from the light source.

3. The light fixture of claim 1, wherein the angled portion extends from the flat portion at an angle defined as between approximately 5 degrees and approximately 80 degrees.

4. The light fixture of claim 1, wherein the angled portion extends from the flat portion at an angle defined as between approximately 10 degrees and approximately 30 degrees.

5. The light fixture of claim 1, wherein the lens is made of a plastic material.

6. The light fixture of claim 1, wherein the housing is rectangular in shape.

7. The light fixture of claim 1, wherein the light source is an LED-based light source.

8. The light fixture of claim 1, wherein the plate includes at least one snap-fit protrusion configured to engage at least one hole on the end panel of the housing to attach the plate to the end panel of the housing.

9. The light fixture of claim 1, wherein the end panel of the housing includes at least one snap-fit protrusion configured to engage at least one hole on the plate to attach the plate to the end panel of the housing.

10. The light fixture of claim 1, wherein the plate includes a fastener that engages a vertical sliding slot allows the plate to be adjusted up and down along the end panel of the housing.

11. The light fixture of claim 1, wherein the plate includes a fastener that engages a horizontal sliding slot that allows the plate to be adjusted side to side longitudinally along the end panel of the housing.

12. A light fixture, comprising:
a housing, the housing comprising a top panel, a pair of side panels, and a pair of end panels, wherein the top panel is attached to a top of each of the side panels and each of the two end panels to form the housing;
an LED-based light source located inside the housing;
a lens configured to mount to the housing, the lens having a length shorter than a longitudinal length of the housing, thereby creating a gap between the lens and at least one end panel of the housing; and
a first plate attached to a first end panel, wherein the first plate includes a flat portion that attaches to the first end panel and an angled portion that extends from the flat portion of the first plate at an angle defined as between approximately 10 degrees and approximately 60 degrees, wherein the angled portion of the first plate covers the gap between the lens and the housing, wherein the angled portion of the first plate retracts against the lens as the lens expands due to heat from the light source.

13. The light fixture of claim 12, further including a second plate attached to a second end panel, wherein the second plate includes a flat portion that attaches to the second end panel and an angled portion that extends from the flat portion of the second plate at an angle defined as between approximately 10 degrees and approximately 60 degrees, wherein the angled portion of the second plate covers the gap between the lens and the housing, wherein the angled portion of the second plate retracts against the lens as the lens expands due to heat from the light source.

14. The light fixture of claim 12, wherein the angled portion extends from the flat portion at an angle defined as between approximately 10 degrees and approximately 30 degrees.

15. The light fixture of claim 12, wherein the lens is made of a plastic material.

16. The light fixture of claim 12, wherein the housing is rectangular in shape.

17. The light fixture of claim 12, wherein the plate includes at least one snap-fit protrusion configured to engage at least one hole on the end panel of the housing to attach the plate to the end panel of the housing.

18. The light fixture of claim 12, wherein the end panel of the housing includes at least one snap-fit protrusion configured to engage at least one hole on the plate to attach the plate to the end panel of the housing.

19. The light fixture of claim 12, wherein the plate includes a fastener that engages a vertical sliding slot allows the plate to be adjusted up and down along the end panel of the housing.

20. The light fixture of claim 12, wherein the plate includes a fastener that engages a horizontal sliding slot that allows the plate to be adjusted side to side longitudinally along the end panel of the housing.
